(19) United States
(12) Patent Application Publication
(10) Pub. No.: US 2010/0011619 A1
(43) Pub. Date: Jan. 21, 2010

(54) METHOD AND APPARATUS FOR ONE PIECE FOOTWEAR CONSTRUCTION

(76) Inventors: Peter Bastianelli, Dunfermline (GB); Chad Kelly, Raytown, MO (US)

Correspondence Address: PATRICK W. RASCHE (23437);ARMSTRONG TEASDALE LLP, ONE METROPOLITAN SQUARE, SUITE 2600, ST. LOUIS, MO, 63102-2740, US

(21) Appl. No.: 12/174,394

(22) Filed: Jul. 16, 2008

(51) Int. Cl. A43B 1/00; B32B 37/02

(52) U.S. Cl. 36/87; 156/73.1

(57) ABSTRACT

A method of fabricating a bootie for use in a footwear item is provided. The method includes laminating a plurality of layers of material together into a single air permeable, moisture vapor permeable, and waterproof sheet, and forming a bootie out of the sheet. The sheet includes a first membrane layer having a first side and a second side; the first layer being air permeable, moisture vapor permeable, and waterproof. The sheet also includes a second protection layer having a first side and a second side. The second layer is positioned between the first layer and an outside environment when the footwear item is completed, and configured to facilitate protecting the first layer from an outside surrounding environment. In addition, the sheet can include a third bonding layer having a first side and a second side. The third layer is positioned between the first layer and the second layer to facilitate bonding of the first layer to the second layer.

### BACKGROUND OF THE INVENTION

This invention relates generally to footwear, and more particularly to a one-piece upper of a shoe and a method of fabricating a one-piece upper of a shoe.

At least some known shoe uppers are constructed of certain materials, including various fabrics and adhesives, that when assembled in layers have limited breathability. Similarly, footwear that is marketed as waterproof and breathable is constructed of multiple layers that might be waterproof and might be moisture vapor permeable but are not air permeable. The waterproof liner most commonly includes a layer of polyurethane or some other material that is not air permeable. This lack of air permeability seals in the wearer's foot without access to fresh air.

Construction of conventional uppers typically involves either the use of a pattern cutout from a material, or multiple pieces cut from a material and either the single piece or the multiple pieces assembled with stitching and adhesives to form a volume shaped to encompass a wearer's foot. Often, uppers are constructed in two parts, a liner and a shoe shell, wherein the waterproof liner must be assembled inside one or more layers of the shoe shell to complete the full upper of the shoe. However, methods used to improve the breathability of the shoe tend to reduce the waterproof capability of the shoe

### BRIEF SUMMARY OF THE INVENTION

In one aspect of the invention, a method of fabricating a bootie for use in a footwear item is provided. The method includes laminating a plurality of layers of material together into a single air permeable, moisture vapor permeable, and waterproof sheet, and forming a bootie out of the sheet. The sheet includes a first membrane layer having a first side and a second side; the first layer being air permeable, moisture vapor permeable, and waterproof. The sheet also includes a second protection layer having a first side and a second side. The second layer is positioned between the first layer and an outside environment when the footwear item is completed, and configured to facilitate protecting the first layer from an outside surrounding environment. In addition, the sheet can include a third bonding layer having a first side and a second side. The third layer is positioned between the first layer and the second layer to facilitate bonding of the first layer to the second layer.

In another aspect of the invention, a bootie for use in a footwear item is provided. The bootie includes a body formed of a sheet of a plurality of laminated layers of material that forming a single air permeable, moisture vapor permeable, and waterproof sheet. The sheet includes a first membrane layer having a first side and a second side; the first layer being air permeable, moisture vapor permeable, and waterproof. The sheet also includes a second protection layer having a first side and a second side. The second layer is positioned between the first layer and an outside environment when the footwear item is completed, and configured to facilitate protecting the first layer from an outside surrounding environment. In addition, the sheet can include a third bonding layer having a first side and a second side. The third layer is positioned between the first layer and the second layer to facilitate bonding of the first layer to the second layer.

In yet another aspect of the invention, an article of footwear including an outsole and a bootie attached to an insole is provided. The bootie includes a body formed of a sheet of a plurality of laminated layers of material that forming a single air permeable, moisture vapor permeable, and waterproof sheet. The sheet includes a first membrane layer having a first side and a second side; the first layer being air permeable, moisture vapor permeable, and waterproof The sheet also includes a second protection layer having a first side and a second side. The second layer is positioned between the first layer and an outside environment when the footwear item is completed, and configured to facilitate protecting the first layer from an outside surrounding environment. In addition, the sheet can include a third bonding layer having a first side and a second side. The third layer is positioned between the first layer and the second layer to facilitate bonding of the first layer to the second layer.

### BRIEF DESCRIPTION OF THE DRAWINGS

FIG. 1 is a perspective view of a footwear item in accordance with an embodiment of the present invention.

FIG. 2 is an enlarged cross-section of a multi-layer laminate sheet used to form the upper shown in FIG. 1.

FIG. 3 is a perspective view of an upper during construction with the inside facing outward.

### DETAILED DESCRIPTION OF THE INVENTION

A common limitation of footwear that is waterproof and moisture permeable is that such footwear is air impermeable. One example of an embodiment that does not exhibit the common air impermeability limitation is footwear having a one-piece upper made from a multi-layer laminate that is waterproof, moisture vapor permeable, and air permeable. The embodiments described herein include such one-piece upper and a method for constructing such a one-piece upper.

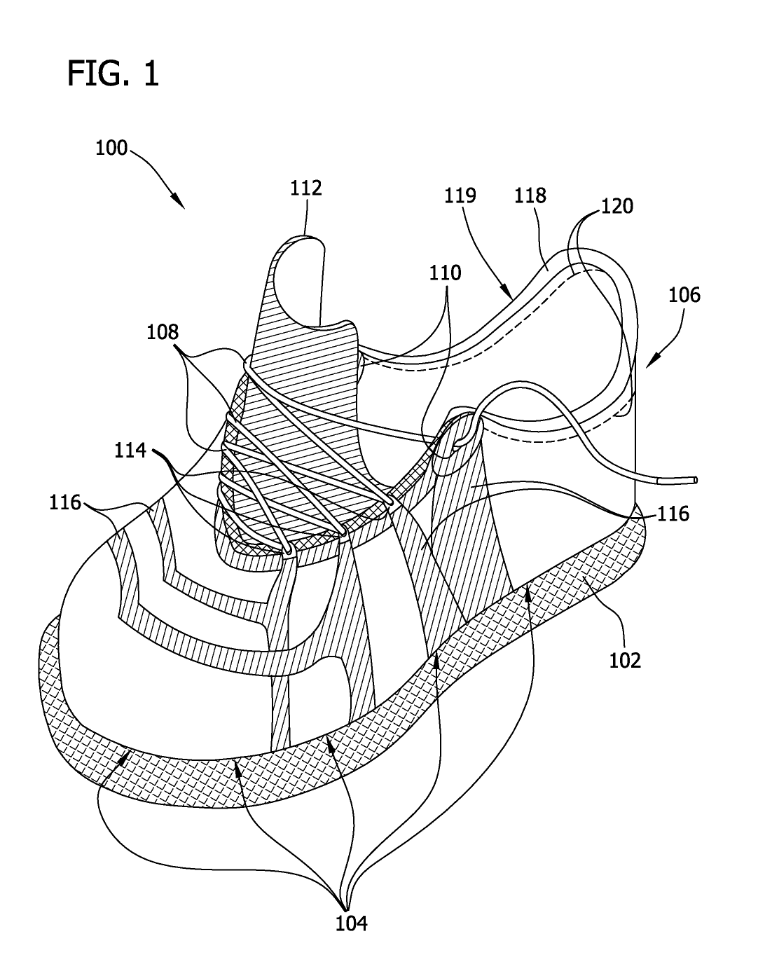

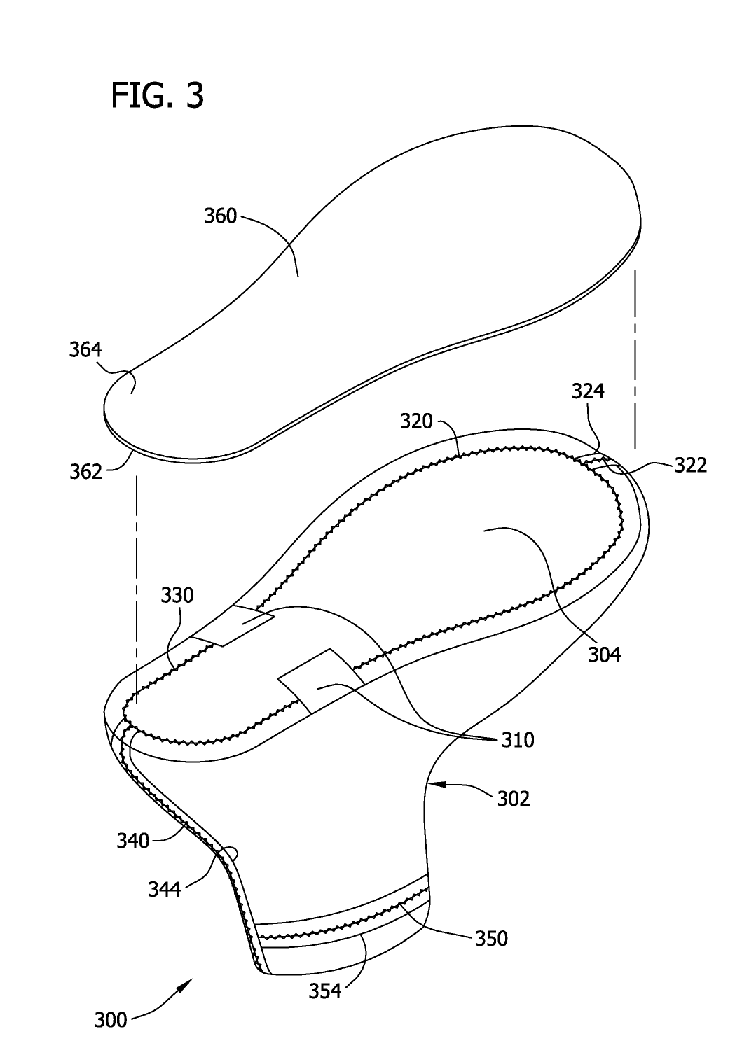

FIG. 1 is a perspective view of a footwear item 100 in accordance with an embodiment of the present invention. In the exemplary embodiment, footwear item 100 is illustrated as an athletic shoe. In various alternative embodiments, footwear item 100 may be another type of shoe, boot or footwear. Footwear item 100 includes an outsole 102, and an upper 104 configured to receive a foot (not shown) of a user. Upper 104 includes a bootie 106 coupled to an insole (shown in FIG. 3). In an alternative embodiment, upper 104 includes a midsole (not shown) layered between the insole and outsole 102. In another embodiment the midsole and outsole 102 may be combined into a single unitary structure. In various other embodiments, the midsole and outsole 102 may be formed and coupled to upper 104 and insole by one or more of injection molding and vulcanizing. Footwear item 100 includes a front lacing 108 that is engaged to upper 104 using a plurality of fasteners 110. Moreover, footwear item 100 includes a tongue 112 configured to permit contraction and expansion of upper 104 of footwear item 100 so that footwear item 100 can accommodate insertions and removal of a foot. Tongue 112 also provides for adjustment of upper 104 so that footwear item 100 is firmly contacting and attached to the foot of the user when front lacing 108 is secured. In an alternative embodiment, front lacing 108 may be a hook and loop fastener material such as Velcro®. Tongue 112 is formed from existing material by tongue stitching 114. Fasteners 110 are attached to upper 104 at the edge of Tongue 112. In various alternative embodiments, fasteners 110 may be one or more of the following: eyelets, eye stays, loop fasteners, and hooks. Footwear item 100 also typically includes an exoskeleton 116 that includes material attached or molded to the outside surface of upper 104. Exoskeleton 116 provides structural support to upper 104 and facilitates maintaining a shape of upper 104. Exoskeleton 116 also facilitates dispersing lacing tension forces that act upon fasteners 110 outwardly across an area surrounding where exoskeleton 116 is attached as opposed to isolating the forces only where fasteners 110 are attached to upper 104. In the exemplary embodiment, exoskeleton 116 is attached to upper 104 by high frequency welding. In various alternative embodiments, exoskeleton 116 is attached using at least one of, but not limited to, stitching, adhesive bonding, and high frequency welding. In the exemplary embodiment, footwear item 100 includes a cap 118 formed by doubling over a top edge 119 of upper 104 and maintained in position using for example, but not limited to, cap stitching 120. In the exemplary embodiment, upper 104 is secured to outsole 102 using an attachment process such as an adhesive process.

The terms ‘waterproof’ and ‘liquid impermeable’ are used interchangeably throughout the present disclosure. As used herein, ‘liquid impermeable’ is defined as that which upper 104, including the insole, does not leak as indicated by the presence of detectable liquid on the exterior of upper 104 when applied with water having maximum pressure of 200 millibar (2.901 p.s.i.g.) for one minute.

In addition, bootie 106 is moisture vapor permeable, which allows perspiration and other vapors to exit bootie 106 while still remaining impervious to fluids such as water. In an exemplary sense, liquid vapor permeability or the moisture vapor transmission rate (MVTR) of bootie 106 is preferably defined by the test method designated ISO 15496, which provides for moisture vapor transmission of at least 337 grams per square meter (9.94 ounces per square yard) or more of water vapor in a twenty-four hour period through bootie 106. Preferably, the moisture vapor transmission rate is between 1,500 grams per square meter to 15,000 grams per square meter of water vapor in a twenty-four hour period through bootie 106.

In an exemplary sense, ‘air permeability’ of bootie 106 can be defined by the test method designated ASTM D737-96, by the American Society for Testing and Materials. This is preferably measured by a Frazier Air Permeability Tester, a Textest FX 3300 Air Permeability Tester or an equivalent type of testing device. The air permeability needs to provide for air flow of at least 0.03 cubic centimeters per minute per square centimeter at a pressure of a 1.27 centimeter water column (0.05 cubic feet per minute per square foot at a pressure of a 0.5 inch water column) through bootie 106 portion of upper 104. Preferably, there is air flow of at least 0.05 cubic centimeters per minute per square centimeter at a pressure of a 1.27 centimeter water column (0.1 cubic feet per minute per square foot at a pressure of a 0.5 inch water column) through bootie 106. More preferably there is air flow of at least 0.15 cubic centimeter per minute per square centimeter at a pressure of a 1.27 centimeter water column (0.3 cubic feet per minute per square foot at a pressure of a 0.5 inch water column) through bootie 106 and most preferably there is air flow of at least 0.51 cubic centimeter per minute per square centimeter at a pressure of a 1.27 centimeter water column (1.0 cubic feet per minute per square foot at a pressure of a 0.5 inch water column) through bootie 106.

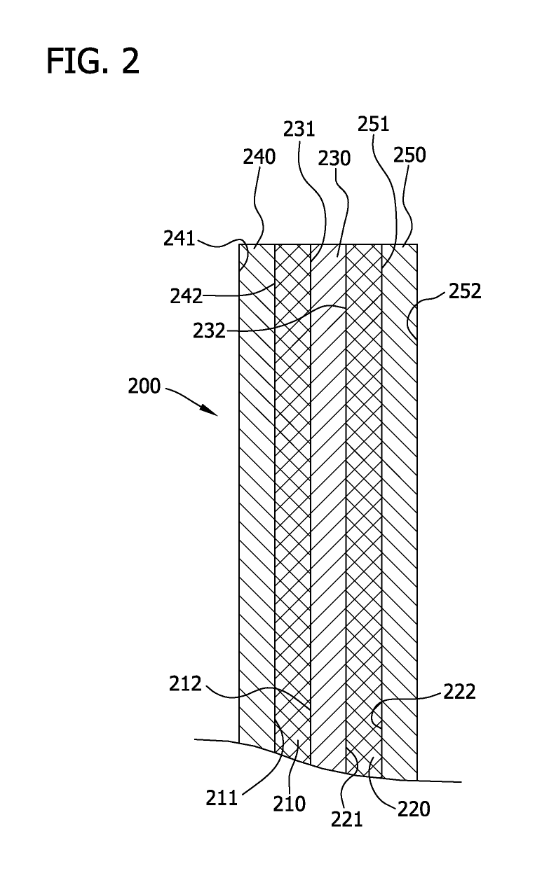

FIG. 2 is an enlarged cross-sectional view of an exemplary embodiment of a multi-layer laminated sheet 200 that may be used in the construction of upper (shown in FIG. 1). In the exemplary embodiment, multi-layer laminated sheet 200 includes five layers. In various other embodiments, other numbers of layers may be used. A first layer 210 is an air permeable, moisture vapor permeable, and waterproof membrane material having a first side 211 and a second side 212. A second layer 220 is a padding material that is waterproof, and has been made air permeable and moisture vapor permeable by perforating the padding material. Second layer 220 includes a first side 221 and a second side 222. Second layer 220 is configured to facilitate protecting first layer 210 from a surrounding environment such as rocks and other externalities that could puncture or otherwise physically damage first layer 210. A third layer 230 is an air permeable and moisture vapor permeable bonding material having a first side 231 and a second side 232. Additionally, third layer 230 can be waterproof. A fourth layer 240 is an air permeable and moisture vapor permeable material having a first side 241 and a second side 242. Fourth layer 240 is configured to facilitate protecting first layer 210 from an inside surrounding environment, such as abrasion by a wearer's foot or sock. Additionally, fourth layer 240 can be waterproof. A fifth layer 250 is an air permeable and moisture vapor permeable material having a first side 251 and a second side 252. Fifth layer 250 is configured to form an outside surface of upper 104 (shown in FIG. 1). Additionally, fifth layer 250 can be waterproof.

In the exemplary embodiment, first layer 210 is formed of an air permeable, moisture vapor permeable, and waterproof material that includes microporous membranes. An example of such material is eVENT® Fabric, which is a chemically treated expanded polytetrafluoroethylene (hereinafter also referred to as ePTFE) membrane commercially available from BHA Technologies, Inc. of Kansas City, Mo.

Other exemplary commercial available materials that may be used for forming multilayer laminated sheet 200 are Gore-Tex™ XCR™ also known as VISI000001, TETRATEX®, SUPOR®, VERSAPOR®, PORELLE®, MILLIPORE®, ENTRANT®, FOLIO I™, ACE-SIL®, FLEX-SIL®, MICROPOR-SIL®, and CELLFORCE®.

Second layer 220 in the exemplary embodiment includes a closed-cell foam such as a polyester fiber foam commercially available as Nu-foam®. In various alternative embodiments, second layer 220 includes at least one of an open-cell foam or other padding-type materials. Although in an exemplary embodiment, the closed-cell foam is waterproof, it is also air impermeable and water vapor impermeable without certain modifications. Therefore to ensure that second layer 220 is air permeable and moisture vapor permeable, the material is perforated prior to being laminated into multi-layer laminated sheet 200. Although second layer 220 is perforated with a plurality of holes to enable it to be air permeable and water vapor permeable, but not waterproof, one or more layers of multi-layer laminated sheet 200, and at least first layer 210, is still waterproof and thus ensures that multi-layer laminated sheet 200 is waterproof.

Third layer 230 includes a bonding material to facilitate bonding of first layer 210 and second layer 220. Third layer 230 facilitates a strong bond that is often otherwise unreliable without the use of third layer 230. In the exemplary embodiment third layer 230 includes a textile material, for example, but not limited to, scrims, tricot knits, and non-wovens.

Fourth layer 240 is configured to form an inside surface, or lining of upper 104 (shown in FIG. 1) and to facilitate protecting first layer 210 from abrasion caused by a wearer's foot (not shown). As such, second layer 220 is configured to be able to withstand periodic abrasion from the wearer's foot as well as provide a level of comfort for the wearer's foot. In the exemplary embodiment, fourth layer 240 includes a textile fabric using at least one of, but not limited to, woven, non-woven, or knit fabrics. Other exemplary fabrics that may be utilized for fourth layer 240 are warp knit fabrics, including the ECLIPSE 100H™ (an abrasive resistant polyester and nylon combination fabric), ECLIPSE 200S™ (an abrasive resistant polyester and nylon combination fabric) and ECLIPSE 400H™ (a lightweight, nylon fabric), all commercial available from Tempo Shain Corporation of Salem, Mass.

Fifth layer 250 is configured to form an outside surface, or shell (not shown) of upper 104 (shown in FIG. 1) and is visible as an outside of shoe 100 (shown in FIG. 1) when worn by a wearer. In an exemplary embodiment, the material used for fifth layer 250 includes, but is not limited to, woven, non-woven, and knit fabrics.

FIG. 3 is an exploded view of a pre-completion upper 300 in accordance with an exemplary embodiment of the present invention during construction. Upper 300 includes an inside facing outward and prior to attaching any combination of a midsole, an outsole 102 (shown in FIG. 1), and an insole sealing gasket 360. In the exemplary embodiment a front toe stitching seam 322 and a rear assembly stitching seam 340 form a one-piece of multi-layer laminate sheet 200 (shown in FIG. 2) into a bootie 302. Bootie 302 and insole 304 are joined with two separate stitching seams. A front insole stitching seam 320 and a rear insole stitching seam 330 are separated by one or more flaps 310 to attach insole 304 to bootie 302. In an alternative embodiment, seams 320 and 330 are separated by only one flap 310 breaking the stitch. In another alternative embodiment, seams 320 and 330 are joined forming a continuous stitch (not shown) attaching bootie 302 to insole 304. Stitching seams 320, 322, 330, 340, and 350 may use any of a wide variety of thread-type material, including, but not limited to, strands or cords and include spun fibers, spun fibers encircling a core filament, bonded fibers and monofilament-type material that may be coated with a liquid impermeable coating. Stitching seams 320, 322, 330, 340, and 350 may also use any of a wide variety of stitching patterns, including, but not limited to: Strobel stitching and zig zag. In addition, adhesives may be utilized as well as electro-die sealing methods. It is also understood that the location and number of seams 320, 322, 330, 340, and 350 can vary depending on the type of footwear item being produced.

Stitching seams 322, 340, and 350 can be sealed with seam tape 324, 344, and 354 positioned over stitching seams 322, 340, and 350 respectively. Heat is then applied through the application of hot air, and pressure through a nip roll is then applied to the top of seam tape 324, 344 and 354. The heat from the hot air is preselected to soften the adhesive in seam tape 324, 344 and 354 without detrimentally affecting any of the desired qualities found in pre-completion upper 300 of footwear item. An application of heat preferably ranges from about 150 degrees Celsius (302 degrees Fahrenheit) to about 250 degrees Celsius (482 degrees Fahrenheit) for most applications. A preferred application of pressure is from about 3 kilograms per square centimeter (42.67 pounds per square inch) gauge to about 5 kilograms per square centimeter (71.12 pounds per square inch) gauge. However, the applied temperature and pressure are dependent on the type of material used for upper 300, the threads used to create seams 320, 322, 330, 340, and 350, the adhesives and the type of material utilized for seam tape 324, 344, and 354. By such a process, a solid structural weld is formed that provides at least a substantially liquid impermeable quality in seams 322, 340, and 350 that is approximately equivalent to the liquid impermeability quality of the remainder of upper 300 and insole 304 having seams 322, 340, and 350, covered and sealed as described further.

Subsequent to seam tape 324, 344, and 354, being applied, and insole 304 being stitched to bootie 302 forming upper 300, an insole sealing gasket 360, having a first side 362 and a second side 364, is applied to upper 300. A bonding agent is applied to first side 362 of insole sealing gasket 360 as well as the base of upper 300 including covering seams 330 and 320, flaps 310, and insole 304. First side 362 of insole sealing gasket 360 is attached to the base of upper 300, covering seams 330 and 320, flaps 310, and insole 304, through the application of heat and pressure as described above. Sealing gasket 360 acts as a sealing agent for front insole stitching seam 320, rear insole stitching seam 330, and flaps 310. By such a process, a solid structural weld is formed that provides at least a substantially liquid impermeable quality in seams 320 and 330, and flaps 310 that is equivalent to the liquid impermeable quality of seams 322, 340, and 350, are with seam tape 324, 344, and 354.

In various alternative embodiments, insole 304 is impervious to both moisture vapor and air. As used herein liquid impermeable is defined as insole 304 not leaking, as indicated by detectable liquid on the exterior of insole 304 when applied with water having maximum pressure of 200 mbar (0.5 p.s.i.g.) for one minute.

In an exemplary embodiment, the absence of air permeability of insole 304 is defined by, for example, a test method designated ASTM D737-96, by the American Society for Testing and Materials. The air permeability is configured to provide for an air flow of less than 0.03 cubic centimeters per minute per square centimeter at a pressure of a 1.27 centimeter water column (0.05 cubic feet per minute per square foot at a pressure of a 0.5 inch water column) through insole 304.

In addition, in an alternative embodiment, insole 304 is substantially impervious to moisture vapor transmission. The liquid vapor permeability or the moisture vapor transmission rate of insole 304 may be defined by the test method designated JIS L 1099:1993 B2 by the Japanese Standards Association, which provides for less than 500 grams per square meter (14.85 ounces per square yard) of water vapor in a twenty-four hour period through insole 304.

In addition, in the exemplary embodiment, insole 304 is substantially inelastic. As used herein, “inelastic” is defined as material that, when subjected to a stress-strain test, provides less than 100% recovery when deflected more than 10% from a yield point.

In the exemplary embodiment, insole 304 includes, but is not limited to, inelastic and thermoplastic material, e.g., sheet goods, such as polypropylene, polyethylene, polyester, inelastic polyurethane, nylon, and vinyl. In an alternative embodiment, insole 304 includes, but is not limited to, fiber reinforced polymeric materials. This can include, but is not limited to, fibers made of polyester, nylon, polypropylene, polyethylene, rayon, and cotton. Yet in another alternative embodiment, insole 304 includes, but is not limited to, an all non-thermoplastic material such as reactive polyurethane, epoxy, styrene, butadiene, acrylic(s), and vulcanized rubber.

Other exemplary commercially available materials that may be used for forming insole 304 are BONTEX®, UPACO™, SOVERE™, MOREL™, ALCANTARA®, VITA™, RHENOFLEX®, and FOOTLEVERS®.

In an alternative embodiment, insole 304 is moisture permeable. Exemplary commercially available materials that may be used for forming a moisture permeable insole 304 are PORELLE®, PORON®, and TEXON®.

Exemplary embodiments of the invention are described above in detail. The methods and components are not limited to the specific embodiments described herein, but rather, components of systems and/or steps of the methods may be utilized independently and separately from other components and/or steps described herein. For example, the methods may also be used in combination with other footwear construction methods, and are not limited to practice with only the construction methods as described herein. Rather, the exemplary embodiment can be implemented and utilized in connection with many other footwear applications.

Although specific features of various embodiments may be shown in some drawings and not in others, this is for convenience only. In accordance with the principles of the invention, any feature of a drawing may be referenced and/or claimed in combination with any feature of any other drawing.

What is claimed is:

1. A method of fabricating a bootie for use in a footwear item, said method comprising:
laminating a plurality of layers of material together into a single air permeable, moisture vapor permeable, and waterproof sheet; and
forming a bootie using the single air permeable, moisture vapor permeable, and waterproof sheet;
wherein the single air permeable, moisture vapor permeable, and waterproof sheet comprises:
a first layer comprising an air permeable, moisture vapor permeable, and waterproof membrane material, having a first side and a second side;
a second layer comprising a padding material, having a first side and a second side, the second layer positioned between the first layer and an outside environment when the footwear item is completed, the second layer configured to facilitate protecting the first layer from an outside surrounding environment; and
the first layer bonded to the second layer.

2. A method in accordance with claim 1 wherein laminating a plurality of layers of material together into the single sheet and forming a bootie comprises laminating a third layer comprising a bonding material, the third layer having a first side and a second side, the third layer positioned between the first layer and the second layer to facilitate bonding of the first layer to the second layer.

3. A method in accordance with claim 1 wherein laminating a plurality of layers of material into said single sheet further comprises laminating a fourth layer having a first side and a second side;
the second side of the fourth layer bonded to the first side of said first layer;
the first side of the fourth layer configured to form the inside surface of the bootie; and
the fourth layer configured to facilitate protecting said first layer from an inside surrounding environment.

4. A method in accordance with claim 1 wherein laminating a plurality of layers of material into said single sheet further comprises laminating a fifth layer having a first side and a second side;
the first side of the fifth layer bonded to the second side of the second layer; and
the second side of the fifth layer configured to form the outside surface of said bootie.

5. A method in accordance with claim 4 wherein laminating a plurality of layers of material into said single sheet further comprises laminating an external support frame onto the fifth layer;
wherein the external support frame comprises a strengthening material coupled to the outside surface by one or more of the following: molding, stitching, adhesive bonding, and high frequency welding.

6. A bootie for use in a footwear item, said bootie comprising:
a body formed of a sheet of a plurality of laminated layers of material, said plurality of laminated layers forming a single air permeable, moisture vapor permeable, and waterproof sheet, wherein said sheet comprises:
a first layer comprising a membrane material, having a first side and a second side, said first layer being air permeable, moisture vapor permeable, and waterproof;
a second layer comprising a padding material, having a first side and a second side, said second layer configured to facilitate protecting said first layer from an outside surrounding environment; and
said first layer bonded to said second layer.

7. A bootie in accordance with claim 6 further comprising a third layer of said plurality of laminated layers, said third layer comprising a bonding material, having a first side and a second side, said third layer positioned between said first layer and said second layer to facilitate bonding of said first layer to said second layer.

8. A bootie in accordance with claim 6 further comprising a fourth layer of said plurality of laminated layers, said fourth layer having a first side and a second side, said second side of said fourth layer bonded to said first side of said first layer, said first side of said fourth layer configured to form the inside surface of said bootie, and said fourth layer configured to facilitate protecting said first layer from an inside surrounding environment.

9. A bootie in accordance with claim 6 further comprising a fifth layer of said plurality of laminated layers, said fifth layer having a first side and a second side, said first side of said fifth layer bonded to said second side of said second layer, and said second side of said fifth layer configured to form the outside surface of said bootie.

10. A bootie in accordance with claim 9 wherein said bootie further comprises an external support frame comprising a strengthening material coupled to said outer surface by one or more of the following: molding, stitching, adhesive bonding, and high frequency welding.

11. An article of footwear comprising a bootie coupled to an insole coupled to an outsole, said bootie comprising:
a body formed of a sheet of a plurality of laminated layers of material, said plurality of layers forming a single air permeable, moisture vapor permeable, and waterproof sheet, said sheet comprising:
a first layer comprising a membrane material having a first side and a second side, said first layer being air permeable, moisture vapor permeable, and waterproof;
a second layer comprising a padding material having a first side and a second side, said second layer configured to facilitate protecting said first layer from an outside surrounding environment; and
said first layer bonded to said second layer.

12. An article of footwear in accordance with claim 11, further comprising a third layer comprising a bonding material having a first side and a second side, said third layer positioned between said first layer and said second layer, said third layer facilitates bonding of said first layer to said second layer.

13. An article of footwear in accordance with claim 11, wherein said bootie further comprises a fourth layer having a first side and a second side, said second side of said fourth layer bonded to said first side of said first layer, said first side of said fourth layer configured to form the inside surface of said bootie, said fourth layer configured to facilitate protecting said first layer from an environment within said bootie.

14. An article of footwear in accordance with claim 11, wherein said bootie further comprises a fifth layer having a first side and a second side, said first side of said fifth layer bonded to said second side of said second layer, said second side of said fifth layer configured to form the outside surface of said bootie.

15. An article of footwear in accordance with claim 14 wherein said bootie further comprises an external support frame comprising a strengthening material coupled to said outer surface by one or more of the following: molding, stitching, adhesive bonding, and high frequency welding.

16. An article of footwear in accordance with claim 11, wherein said article of footwear further comprises:
a front insole stitching seam joining said insole to said bootie, said front insole stitching seam extending at least partially about a toe-end of said insole; and
a rear insole stitching seam joining said insole to said bootie, said rear insole stitching seam extending at least partially about a heel-end of said insole, wherein one or more gaps exists between said front insole stitching seam and said rear insole stitching seam.

17. An article of footwear in accordance with claim 16, further comprising an insole sealing gasket bonded to said upper, said insole sealing gasket positioned to substantially cover said insole, said front insole stitching seam, and said rear insole stitching seam, insole sealing gasket configured to form a seal that is substantially liquid impermeable.

18. An article of footwear in accordance with claim 17, further comprising a first flap extending from said bootie, said first flap is positioned between said insole and said gasket, said first flap extends from bootie and overlaps a first gap between a first end of said insole stitching seam and a first end of said rear insole stitching seam.

19. An article of footwear in accordance with claim 18, further comprising a second flap extending from said bootie, said second flap is positioned between said insole and said gasket, said second flap extends from bootie and overlaps a second gap between a second end of said insole stitching seam and a second end of said rear insole stitching seam.

20. An article of footwear in accordance with claim 19, wherein said insole sealing gasket is positioned to cover said insole, said first flap, said second flap, said front insole stitching scam, and said rear insole stitching seam, and form a seal that is substantially liquid impermeable.
